(19) United States
(12) Patent Application Publication
(10) Pub. No.: US 2009/0240652 A1
(43) Pub. Date: Sep. 24, 2009

(54) AUTOMATED COLLECTION OF HUMAN-REVIEWED DATA

(76) Inventors: Qi Su, Mountain View, CA (US); Dmitry Pavlov, San Jose, CA (US); Jyh-Herng Chow, San Jose, CA (US); Wendell Craig Baker, Palo Alto, CA (US)

Correspondence Address: MPG, LLP AND YAHOO! INC., 710 LAKEWAY DRIVE, SUITE 200, SUNNYVALE, CA, 94085, US

(21) Appl. No.: 12/051,608

(22) Filed: Mar. 19, 2008

(51) Int. Cl. G06F 17/30

(52) U.S. Cl. 707/1; 707/E17.001

(57) ABSTRACT

The embodiments of the present invention provide methods and systems for automated collection of human-reviewed data. Requesters send data to be reviewed by humans (or data requests) to a data processing system, which is in communication with one or more systems for collecting human-reviewed data (HRD). The methods and systems discussed enables the data processing system to work with one or more of the systems for collecting HRD). In one embodiment, between the data processing system and the systems for collecting HRD are wrappers, which stores parameters specific to the data requests and libraries for transforming the data requests to human intelligent tasks (HITs) specific to each HRD system. The data processing system also includes a number of components that facilitate transforming data requests into HITs, sending the HITs to the HRD collection systems, receiving HRD, and analyzing HRD to improve the quality of collected HRD.

### BACKGROUND OF THE INVENTION

1. Field of the Invention

This invention relates generally to automated collection of human reviewed data.

2. Description of the Related Art

Human-reviewed data are critical in Internet commerce, information collection, and information exchange. For example, items that are for sale on Internet web sites and jobs posted on job search sites need to be placed on categories that make sense to Internet shoppers and job seekers respectively. Determining which category each for-sale item or each job should appear under may require human intelligence. Other examples of data that need to be reviewed by humans include, but not limited to, verifying if a correct picture or description corresponding to a car model has been place in the advertisement, and checking if a picture or a video posted by an online user is offensive or inappropriate.

Human intelligence is needed in labeling datasets, such as categorizing an item for sale, and for quality monitoring, such as monitoring the relevance of search results. Human intelligence is also needed in web content approval, which may include approval of user-generated content, such as web pages, pictures and videos, and correcting content of web site(s).

Human-reviewed data need to be collected and analyzed since they are useful for Internet commerce, information collection, and information exchange. It is in this context that embodiments of the present invention arise.

### SUMMARY OF THE INVENTION

The embodiments of the present invention provide methods and systems for automated collection of human-reviewed data. Requesters send data to be reviewed by humans (or data requests) to a data processing system, which is in communication with one or more systems for collecting human-reviewed data (HRD). The systems for collecting HRD can be systems for internal expert or editorial staff, systems for outsourced service-providers, systems for an automated market place, such as Amazon Mechanical Turk, or systems for online question and answer or discussion forums.

The methods and systems discussed enables a data processing system to work with one or more of the systems for collecting HRD. In one embodiment, between the data processing system and the systems for collecting HRD are wrappers, which store parameters specific to the data requests to human intelligence tasks and libraries for transforming the data requests to human intelligent tasks (HITs). The data processing system also includes a number of components that facilitate transforming data requests into HITs, sending the HITs to the HRD collection systems, receiving HRD, and analyzing HRD to improve the quality of collected HRD. The flexible systems and methods enable using existing HRD collection systems with minimum amount of engineering. The systems and methods can be reused for different applications that consume HRD using different HRD collection systems. The features described above enable harnessing the scale of Internet-based HRD collection system while ensuring the quality, such as accuracy, of the data collected.

It should be appreciated that the present invention can be implemented in numerous ways, including as a method, a system, or a device. Several inventive embodiments of the present invention are described below.

In accordance with one embodiment, a method of automated collection of human-reviewed data (HRD) is provided. The method includes receiving a data request from a requester by a data processing system. The data processing system defines a task design component, a task dispatcher component, a result poller component and a result analyzer component. The method also includes transforming the data request into one or more human intelligence tasks (HITs) with the assistance of the task design component of the data processing system. Each HIT is specific to a respective HRD collection system. The method further includes sending each HIT to the respective HRD collection system by using the task dispatcher component. In addition, the method includes collecting the HRD from each HRD collection system with the assistance of the result poller component. The HRD is provided by an answerer based on each HIT. Additionally, the method includes analyzing the collected HRD with the assistance of the analyzer component. The analysis improves the accuracy of the HRD collected. Further, the method includes sending the analyzed collected HRD to the requester.

In another embodiment, a system for automated collection of human-reviewed data (HRD) is provided. The system includes a data processing system for receiving data request from a requester. The system also includes an HRD collection system for collecting HRD corresponding to the data request. The HRD collected are entered by an answerer interacting with the HRD collection system. The system further includes a system with a wrapper between the data processing system and the HRD collection system. The wrapper and the data processing system transform the received data request into a human intelligence task (HIT) to be sent to the HRD collection system for the answerer to view to prepare the HRD corresponding to the data request. The wrapper and the data processing system analyze the collected HRD to improve the accuracy of the HRD collected.

In yet another embodiment, computer readable media including program instructions for automated collection of human-reviewed data (HRD) are provided. The computer readable media include program instructions for receiving a data request from a requester by a data processing system. The data processing system defines a task design component, a task dispatcher component, a result poller component and a result analyzer component. The computer readable media also include program instructions for transforming the data request into one ore more human intelligence tasks (HITs) with the assistance of the task design component of the data processing system. Each HIT is specific to a respective HRD collection system. The computer readable media further include program instructions for sending each HIT to the respective HRD collection system by using the task dispatcher component. In addition, the computer readable media include program instructions for collecting the HRD from each HRD collection system with the assistance of the result poller component. The HRD is provided by an answerer based on each HIT. Additionally, the computer readable media include program instructions for analyzing the collected HRD with the assistance of the analyzer component. The analysis improves the accuracy of the HRD collected. Further, the computer readable media include program instructions for sending the analyzed collected HRD to the requester.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 shows a system for collecting human-reviewed data, in accordance with one embodiment of the present invention.

FIG. 2A shows a questioning page posted by a HRD collection system, in accordance with one embodiment of the present invention.

FIG. 2B shows a questioning page, in accordance with another embodiment of the present invention.

FIG. 2C shows a task page for a member of editorial staff, in accordance with one embodiment of the present invention.

FIG. 2D shows a wrapper, in accordance with one embodiment of the present invention.

FIG. 2E shows a category library, in accordance with one embodiment of the present invention.

FIG. 3A shows a diagram of an automated human-review data collection system, in accordance with one embodiment of the present invention.

FIG. 3B shows a Result Analyzer component, in accordance with one embodiment of the present invention.

FIG. 4 a process flow of collecting HRD from an automated HRD collection system, in accordance with one embodiment of the present invention.

### DETAILED DESCRIPTION

As mentioned above, human-reviewed data are critical in Internet commerce, information collection, and information exchange. Human-reviewed data need to be collected and analyzed to be useful for Internet commerce, information collection, and information exchange.

For example, human-reviewed data are critical in content-focused verticals, such as web sites that promote products and services related to categories like “Travel”, “Local”, “Shopping”, “Movies”, etc. These content-focused verticals aggregate data from multiple sources to produce value-added content to be consumed by Internet users. The automated data processing pipelines used to aggregate data to create the content of these verticals are implemented by complex software systems. However, human intelligence and intervention are still needed in creating the content.

Human-reviewed data are needed for content consumption by automated data processing systems. Datasets (or information) often need to be labeled to be useable by users. For example, a hotel in San Francisco (“Hotel-SF”) is listed in a Travel site or a Travel section of a large web site. The web page of the hotel (or “Hotel-SF”) needs to be labeled or tagged properly so that when a user searches the Internet for a hotel in San Francisco, the web page or a link to the web page of the hotel (“Hotel-SF”) will appear in the search results. The labeling or tagging of the web page of the hotel may need to be performed by humans. Alternatively, users of the Travel site can also browse the site to find “Hotel-SF” under a specific category, such as under the category of Hotel, which is further under a city category of “San Francisco”. The categorization of “Hotel-SF” to be placed under the category of Hotel and upper-category of San Francisco may need to be performed by humans because only humans understand how other humans see or view things. Furthermore, in the cases where each labeling or tagging is performed by automated methods without human intervention, such automated methods still need to be periodically reviewed by humans for quality assurance. In the cases where such automated methods entail an artificial-intelligence-machine learning algorithm, human labeling is required to create a labeled training dataset to train the algorithm.

In addition, human intelligence is needed for quality monitoring of user experience of a web site. For example, if a web site sells books online, the web site (or the administrator of the web site) wants to make sure that users can find the books they want easily. The web site could hire staff or outside personnel conducting search tests on the web site to check if the desired items can be found easily and if the search results returned are relevant. The quality monitoring work requires human intelligence.

Human-reviewed data are also needed for content approval. User-generated content would require human approval and/or abuse detection. For example, currently many social networking sites, such as MySpace, or video-sharing sites, such as YouTube, allow users to post pictures or videos to be viewed by the general public. Most pictures and videos posted by users on these sites are appropriate for consumption by the general public. However, some users do post pictures or videos that could be considered offensive or inappropriate to the general public. To ensure offensive and inappropriate content, which could include words, description, pictures, videos, and audios, are not posted on web sites, these web sites often hire staff or personnel, either internal or external, to check the content to ensure users do not post inappropriate content and abuse the system. In addition, existing labeled datasets and content posted on web sites might contain errors that need to be corrected. Detecting and correcting these errors often require human intelligence.

There are many types of data that need to be reviewed by human beings. The types of data that need to be reviewed by human described above are merely examples. Other types of data that need to be reviewed by human are also possible.

Currently there are a few existing mechanisms for collecting aforementioned human-reviewed data. For example, the jobs of categorization of for sale items on Yahoo! Shopping can be performed in-house experts or editorial staff from Yahoo!. The editorial staff is trained and understands how Internet users view and search products and services on web sites. Another example is the jobs of determining the appropriateness of user-generated pictures posted on MySpace being sent to external service providers to manually verifying the appropriateness of each picture.

Another way to collect human-reviewed data is through automated market places, such as Amazon Mechanical Turk (MTurk) and Floxer.com to collect human-reviewed data. Amazon MTurk and Floxter.com are web sites that list jobs associated with data that need to be reviewed by humans. Jobs, or HITs (human intelligence tasks) of data that need to be reviewed by humans can be posted on MTurk web site or Floxter.com by administrators of these web sites or owners of the data (or requesters of human-reviewed data). Human-reviewed data collected by Amazon Mechanical Turk (MTurk) or Floxer.com can include a great varieties. For example, one of the job, or HIT (human intelligence task) posted MTurk could be asking answerers (or workers) of MTurk to prepare a transcript of an audio, and another HIT could be asking answerers to verify transcripts of audios prepared by others. Answerers (or workers) go to an MTurk site or a Floxter site to obtain the jobs and to enter their inputs based on their human intelligence.

Yet another way to collect human inputs on data is through Internet forums and online “questions and answers (Q&A),” such as Yahoo! Answer. Data owners (or human-reviewed data requesters) that want their data to be reviewed by humans or a system administrator can post the data of the requesters in the form of questions to solicit answers from other online users (or Internet users). The human-reviewed data might arrive in a form that requires pre-processing before they are useful. For example, in Y! Answers, a question “What is the brand of the product ‘Sanford Prismacolor Nupastel Pastel Sets 24 Color Set’?” is asked. The answers returned could be “Sanford is the brand,” or “manufacturer of the Nupastel Pastel set,”, or “It's Sanford—Prismacolor.” The results require parsing before they become useful or get to the true answer(s).

Different types of collection mechanisms for human-reviewed data yield results with varying qualities and formats. For example, human-reviewed data collected through Internet forums could have relatively poor quality, such as poor accuracy, since the persons who provide answers are not paid. Also anyone can provide answers, whether the person really have the knowledge on the subject or not. Further, the answers can be provided in a different written formats depending on the styles of the persons who provide the answers. In contrast, human-reviewed data provided by trained editorial staff and paid service-providers generally have higher qualities, since the editorial staff and outsourced service-providers are trained. However, human-reviewed data collected by trained editorial staff or outsourced service-providers are limited by their scalabilities. Outsourced service-providers require significant overhead to handle the business relationship. The overhead may include negotiating contracts, communicating requirements, and startup training etc. In-house staff (such as editorial staff) is typically highly efficient, but are expensive to hire and train.

In contrast, the mechanisms using automated market places, such as MTurk and Floxter, and Internet forums or online Q&A, such as Yahoo! Answers, have the potential to scale to the Internet audience without the aforementioned limitations. However, each mechanism has its own limitations as well. As mentioned above, for the mechanisms using automated market places and Internet forums or online Q&A, the answerers providing human-reviewed data are Internet users. These Internet users does not have contractual relationships with the data-requesting parties, hence the requesting parties may need to resort to external mechanisms to ensure the quality, or accuracy, of human-reviewed data collected.

Embodiment of architectures and systems in which automated data processing systems interact with internal or external human-reviewed data collection systems (or mechanisms) are proposed to enable collecting human-reviewed data (HRD) from different systems. In addition, the architectures and the systems are designed to meet the different scalabilities of these different human-reviewed data collection systems. In these embodiments of architectures and systems, wrapper interfaces to the human-reviewed data collection systems are constructed. Existing data processing systems would send requests for human-reviewed data to the wrappers, as well as asynchronously receive human-reviewed data back from the wrappers.

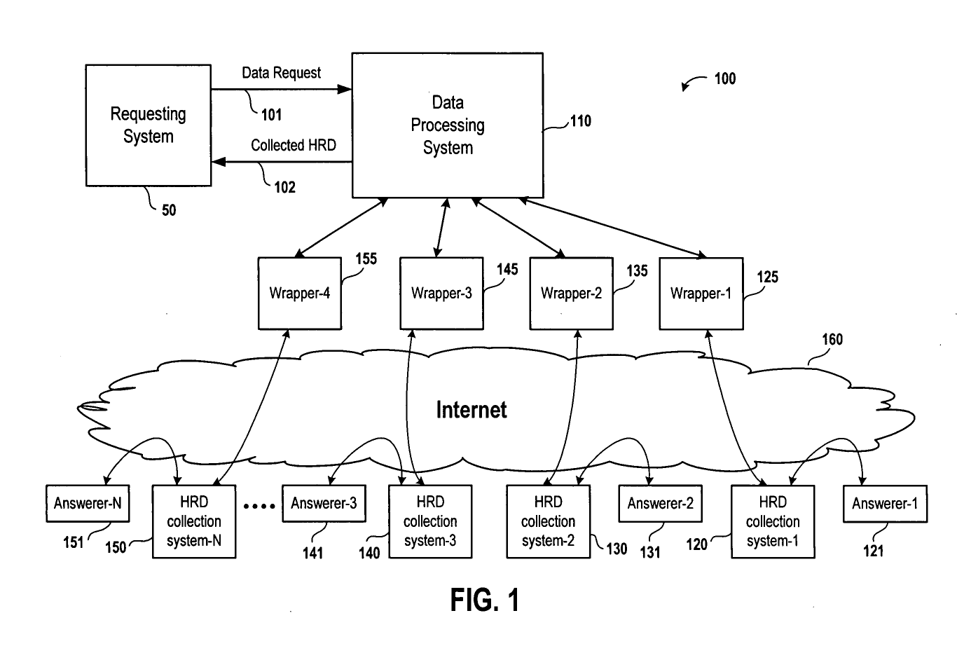

FIG. 1 shows a system 100 for collecting human-reviewed data, in accordance with one embodiment of the present invention. System 100 also illustrates an architecture for collecting human-reviewed data. In system 100, there is a Data Processing System 110, which takes in Data Request (or data that need to be reviewed by humans) 101. The Data Processing System 110 is in communication with N number of systems, used to collect human-reviewed data, such as HRD Collection System-1 120, HRD Collection System-2 130, HRD Collection System-3 140, . . . , and HRD Collection System-N 150. “N” could be any integer. System of Answerer-1 121 is in communication with HRD Collection System-1 120. System of Answerer-2 131 is in communication with HRD Collection System-2 130. System of Answerer-3 141 is in communication with HRD Collection System-3 140. System of Answerer-N 151 is in communication with HRD Collection System-N 150.

In one embodiment, the Data Processing system 100 is in communication with these HRD collection systems, such as systems 120, 130, 140, and 150, through Internet 160. In another embodiment, the Data Processing system 100 is in communication with these HRD collection systems, such as systems 120, 130, 140, and 150, directly and not through Internet 160. Systems of the answerers, such as systems 121, 131, 141, and 151, can be in communication with the HRD collection systems, such as systems 120, 130, 140, and 150, through Internet or not through Internet.

The systems used to collect human-reviewed data could be any system that enables answerers (or workers) to access data that need to be reviewed and to provide inputs (or comments, or answers) on the data. For example, the HRD Collection System-1 120 could be Amazon MTurk, which is open to the all Internet users. Any Internet user, such as Answerer-1 can access Amazon MTurk through system of Answerer-1 121 to view the HITs (human intelligent tasks) that need to be worked on by humans and be a potential answerer for Amazon MTurk. A HIT is a question that needs an answer. Requesters put out Data Request 101 through Requesting System 50 and the Data Request 101 is turned into one or more HITs to be answered. Some HITs are more difficult and the answerers interested in working on these more difficult HITs need to be qualified first. Requesters evaluate the answers from the answerers and decide whether to pay or not. The answerers, such as Answerer-1 of system 121, of Amazon MTurk are Internet users.

The HRD Collection System-2 130 could be Floxter.com, which is also open to all Internet users. Any Internet user, such as Answerer-2 of system 131 can access Floxter.com to view the HITs (human intelligent tasks) that need to be worked on by humans and be a potential answerer (or worker), such as Answerer-2, for Floxter.com. The HRD Collection System-3 140 could be a system belonging to one of the outsourced service providers, which takes in the data (to be reviewed) and assign the data to one of the answerers, such as Answerer-3 of system 141. The HRD Collection System-N 150 to could be a system belonging to trained editorial staff such as Yahoo! editorial staff who are experience in categorizing and reviewing data. Members of the editorial staff, such as Answerer-4 of system 151, can review data to give comments to the data. The trained editorial staff can be internal staff members and the connection between system 150 and the Data Processing System 110 could be direct, and not through Internet 160.

The HRD collection systems can be as many as possible (or N can be as large as possible). As discussed above, Internet forums and online “questions and answers (Q&A),” such as Yahoo! Answer, can also be used as HRD collection mechanisms or systems. Some HRD collection systems are not open to the general public, such as Google's Image Labeler for collecting image tags; however, they can also be in communication with the Data Processing System 110.

The Data Processing System 110 takes in Data Request 101 and sends the data in the data request 110 to be reviewed by answerer(s) in one or more HRD collection systems, such as systems 120, 130, 140, or 150. The answerer(s) at these one or more HRD collection systems provide answers and the answers are transferred back to the Data Processing System 110, which then provide the collected HRD (human-reviewed data) 102 back to the Requesting System 50. The example in FIG. 1 shows only one Requesting System 50. However, there could be as many requesting systems, similar to Requesting System 50, interacting with Data Processing System 110 by sending data requests and receiving collected HRD.

Different HRD collection systems, such as systems 120, 130, 140, and 150, have different formats in receiving data requests, in presenting tasks (HITs) to the answerers and in collecting answers regarding these tasks (or requests). For example an HRD collection system, such as Amazon MTurk or an online Q&A, might allow its requesters to design the questions and formats of collecting and answers. A HIT may ask an answerer to give answers in free-style (or type in what comes to mind) or ask an answerer to choose an answer out of a list of choices. For example, the HITs of Amazon MTurk are designed to be understood by Internet users. In contrast, a member of trained editorial staff might receive the data requests (or HITs) in different formats from those in Amazon MTurk. Trained editorial staff is likely specialized in some fields and are likely to get HITs in those fields. The HITs that are specific in that field would likely come in different formats from the more generic questions in Amazon MTurk.

The Data Processing System 110 takes in the Data Request 101 and work with various HRD collection systems, such as systems 120, 130, 140, and 150. Since each of these HRD collection systems has its own format of incoming data and collecting HRD, a wrapper, such as Wrapper-1 125, Wrapper-2 135, Wrapper-3 145, and Wrapper-4 155, is typically needed between the Data Processing System 110 and each of the HRD collection systems, such as systems 120, 130, 140, and 150, as shown in FIG. 1.

The wrapper between the Data Processing System 110 and each of the HRD collection systems transforms the Data Request 101 to a format acceptable to each of the HRD collection systems that the wrapper is in communication with. In addition, the wrapper also receives the human-reviewed data (HRD) from the HRD collection system that it is in communication with and transforms the collected HRD into the data format needed or requested by the data processing system 110. For example, if a HIT requires human intelligence to determine which categories do Product-A and Product-B belong to determine where to put Product-A or Product-B for sale in a web site. The Requesting System 50 of this task provides information needed to prepare the HIT, such as the descriptions of Product-A and Product-B and a number of categories to choose from. When such a HIT is provided to users (answerers) of Amazon MTurk, the product description of Product-A, and the number of possible categories are needed to prepare the HIT in a format understandable by answerers (or users) on Amazon MTurk.

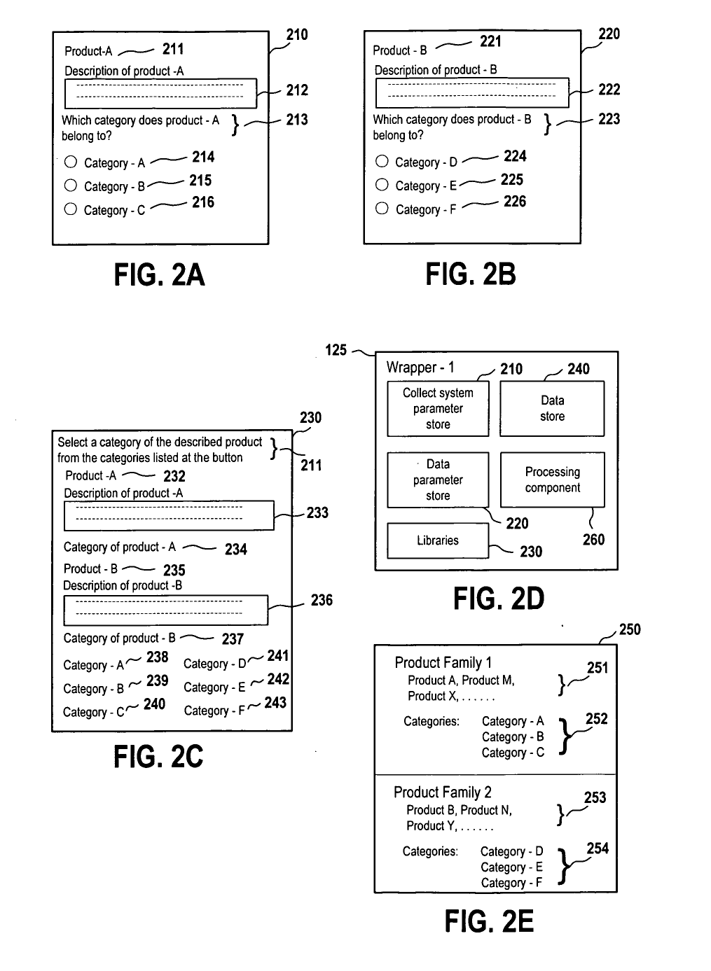

FIG. 2A shows an exemplary questioning page 210 posted by a HRD collection system, such as Amazon MTurk, in accordance with one embodiment of the present invention. In questioning page 210, there is a field of title 211 of Product-A. Below the title 211, there is a product description field 212 of Product-A. Below the product description field 212, there is a question field 213, which list the question of “Which category does Product-A belong to?” At the bottom of FIG. 2A, three categories, Category-A 214, Category-B 215, and Category-C 216, are listed for answerer(s) to select one of them. FIG. 2B shows an exemplary questioning page 220 posted on Amazon MTurk for Product-B. In questioning page 220, there is a field of title 221 of Product-B. Below the title 221, there is a product description field 222 of Product-B. Below the product description field 222, there is a question field 223, which list the question of “which category does Product-A belong to?” At the bottom of FIG. 2B, three categories, Category-D 224, Category-E 225, and Category-F 226, are listed for answerer(s) to select one of them.

In contrast, similar jobs could be provided to trained editorial staff in a different format. FIG. 2C shows an exemplary task page 230 for a member of editorial staff to categorize Product-A and Product-B. At the top of the task page 230, there is a task description field 231, which lists the task requirement, which is to “Select a Category of the Described Product from the Categories listed at the bottom.” The title 232 of Product-A is listed, followed by the product description field 233 of Product-A. Below product description field 233 is a category description field 234 for the answerer (or member of editorial staff) to enter (or write in). The title 235 of Product-B is listed, followed by the product description field 236 of Product-B. Below product description field 236 is a category description field 237 for the answerer (or member of editorial staff) to enter (or write in). At the bottom of task page 230, the different categories, including Category-A 238, Category-B 239, Category-C 240, Category-D 241, Category-E 242, and Category-F 243, are listed. The categories are not listed separately in two groups with each group under each product, as in FIGS. 2A and 2B, because the members of the editorial staff are highly trained and do not require such separate listings.

As shown in FIGS. 2A, 2B, and 2C, different HRD collection systems might have different types of answerers and might use different formats in presenting data to be reviewed and collecting human-reviewed data. Therefore, different wrappers are needed to prepare the tasks in the formats required by different HRD collection systems. Due to different HRD collecting formats, the collected HRD need to be extracted differently to get the meaning results out. For example, when an answerer views the questions in FIG. 2A and FIG. 2B, the answerer clicks on one of the three categories in FIG. 2A and in FIG. 2B. Since the answers are pre-defined in categories, the selected answers are precise. In contrast, some HRD collection systems, such as Internet forums and online “questions and answers (Q&A),” allow users (or answerers) to give comments or inputs in free-style. Their answers need to be parsed first before the answer become useful. For example, if the question of which category does Product-A belong to is posted in the online Q&A. The answer can come back in the form of “I think Product-A should belong to Category-A.” The answer needs to be parsed to become “Category-A.”

In one embodiment, the wrapper between the Data Processing System 110 and each HRD collection system performs the functions of translating the data request sent by the Data Processing System 110 or the Requesting System 50 to a format required by the HRD collection system. In another embodiment, the wrapper parses the collected HRD to results that are needed by the Data Processing System 110 or Requesting System 50. The Data Processing System 110 interacts with the Requesting System 50 to make sure that the Data Request 101 contains sufficient information for the HRD collection systems to collect HRD.

Each of the wrappers, such as wrappers 125, 135, 145, and 155, has a configuration detailing parameters specific to the operation of the underlying human-reviewed data collection system (or mechanism), such as system 120, 130, 140, or 150, as well as the Requesting System 50, which can be an application that requires human-reviewed data. For example, if the underlying mechanism (or system) is Amazon Mechanical Turk (or MTurk), the configuration needs to specify an MTurk account number. The configuration also needs to specify parameters specific to the data being reviewed, e.g. how many answers to collect per task, how much time is a task available for, how much time does an answerer have to answer (or respond to) the task, etc. In one embodiment, the wrappers include a set of libraries for interacting with existing data collection systems (e.g. Amazon Mechanical Turk, Y! Answers, Y! Suggestion Board, Floxter.com, etc). The configuration features and the set of included libraries create a flexible architecture and a flexible system for interacting with available, or existing, human-reviewed data collection mechanisms (or systems). In one embodiment, the wrappers also include a data store component for persistent storage of a list of the submitted requests (so as to be able to track their status) as well as collected HRD (or retrieved answers). In one embodiment, the wrappers also include a data processing component. For example, users response on Yahoo! Answers tend to be conversational and usually require parsing to extract the users intended answers. The data processing component is used to perform the required parsing to extract the intended answers.

FIG. 2D shows an embodiment of Wrapper-1 125, which interacts with the Data Processing System 110 and HRD Collection System-1 120. Wrapper-1 125 includes a collection system parameter store 210, which stores parameters specific to the operation of HRD Collection System-1 120. For example, if the HRD Collection System-1 120 is Amazon MTurk, the account number of the Data Processing System 110 of the Amazon MTurk (system 120) is stored in the collection system parameter store 210. All the parameters specific to the operation of HRD Collection System-1 120 is stored here. In one embodiment, Wrapper-1 125 also include a data parameter store 220, which stores parameters specific to the data being reviewed, e.g. how many answers to collect per task, how much time is a task available for, how much time does an answerer have to answer (or respond to) the task, etc. Those parameters are specific to that wrapper, and hence specific to a given HRD system. A data request may be transformed into multiple HITs to multiple HRD systems. A data request can be transformed into one HIT to Amazon Mechanical Turk asking for 3 answers, one HIT to Yahoo! Answers asking for 3 answers, and one HIT to our own review staff asking for one answer. The one Amazon Mechanical Turk HIT request goes through the MTurk wrapper, which instructs the MTurk HRD system that 3 answers need to be collected, as well as other relevant parameters.

In one embodiment, Wrapper-1 125 include a set of libraries 230 for interacting with the HRD Collection System 120. For example, the libraries 230 might include a category library 250, as shown FIG. 2E, for the company that makes Product-A and Product-B mentioned in FIGS. 2A and 2B. FIG. 2E shows a list of products 251 under Product Family 1 and a list of categories 252 the products in Product Family 1 should be categorized under. FIG. 2E also shows a list of products 253 under Product Family 2 and a list of categories 254 the products in Product Family 2 should be categorized under.

When a requester of this company send a data request of “Product-A” and “Product-B”, Wrapper-1 125 uses the data request to find out that Product-A belongs to Product Family 1 and should be checked under Category-A, Category-B, and Category-C. Wrapper-1 125 also uses the data request to find out that Product-B belongs to Product Family 2 and should be checked under Category-D, Category-E, and Category-F. Using this information, the wrapper can assist in transforming the data request into HITs, as shown in FIGS. 2A and 2B.

In another embodiment, Wrapper-1 125 can also include a data store 240 to store a list of submitted requests, in order to track their status, and collected HRD. In yet another embodiment, Wrapper-1 125 includes a data processing component 260, which processes data collected from the HRD Collection System 120. For example, HRD Collection System 120 might collect the HRD in a conversational style. The HRD would need to be parsed to obtain the true answer(s). The processing component 260 performs the processing function of parsing the results. The wrapper's processing component (260) is specific to the corresponding HRD system (120). For example, the MTurk wrapper is responsible for parsing the XML or other textual format that is returned by MTurk. The Yahoo Answers wrapper is responsible for parsing the XML or other textual format returned by Yahoo Answers, as well as parsing the conversational user responses.

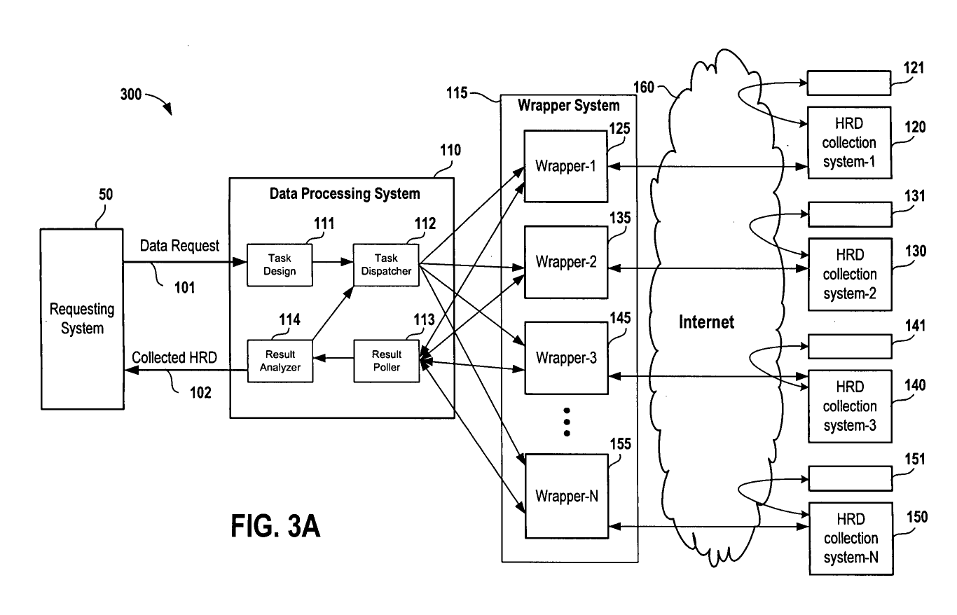

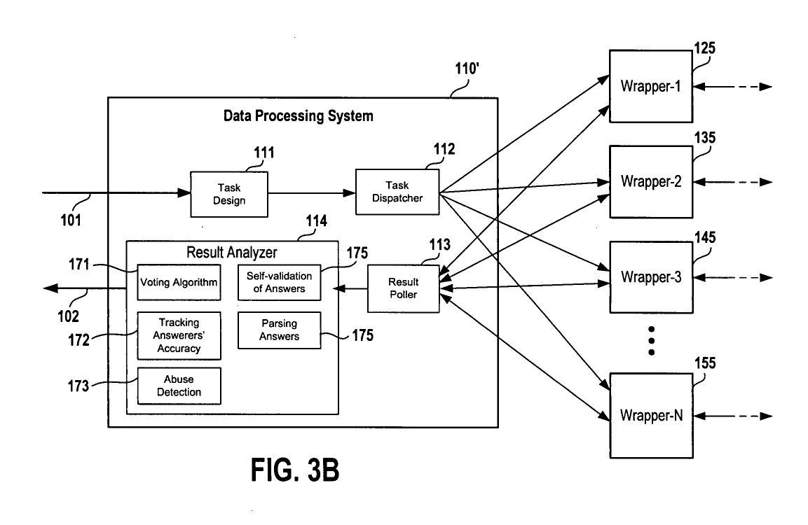

FIG. 3A shows an embodiment of a diagram of an automated human-review data collection system 300. In this embodiment, a requester (not shown) at a Requesting System 50 submits Data Request 101 to the Data Processing System 110 to collect human-reviewed data. The requester utilizes the Requesting System 50 to specify the data to be reviewed by answerers of the HRD collection systems, such as HRD collection systems 120, 130, 140, and 150, and parameters related to collecting the HRD, such as the targeted data collection mechanisms (or systems), rewards for the answerers, boundary conditions to stop collecting answers, and gold-standard datasets (if available) for quality measurement, etc. In the embodiment shown in FIG. 3A, only one Requesting System 50 is shown. In real application, any number of requesting systems, such as Requesting System 50, is possible. Different requesters corresponding with different requesting systems can come from same or different organizations, companies, and geographical locations.

Examples of boundary conditions to stop collecting answers (or human-reviewed data) discussed above may include stopping collecting answers (or human-reviewed data) when a set number of answers are collected or stopping collecting answers after a number of returned answers match one another, etc. Gold-standard datasets are datasets (or data to be reviewed by answerers) with known answers. They can be used to test the qualification of the answerers.

In one embodiment, the Data Processing System 110 has a Task Design component 111 for interacting with Requesting System 50 to collect information needed to prepare data needed to be reviewed into HITs (human intelligence tasks). Using the example in FIGS. 2A, 2B, and 2C, information related to the product title, product description, the categories to be chosen from, and other data collection parameters, such as how many answers to collect, how much time is a task available for, how much time does an answerer have to answer (or respond to) the task, etc. The Task Design component 111 collects information needed to design tasks to be performed by the answerers. In one embodiment, the Task Design component 111 further uses the information collected from the Requesting System 50 to prepare HITs.

In one embodiment, the Data Processing System 110 also has a Task Dispatcher component 112 for issuing the tasks of reviewing the data (or HITs) to the specified HRD collection mechanisms (or systems) by interacting with the corresponding wrappers, such as wrappers 125, 135, 145, and 155. In one embodiment, the wrappers, 125, 135, 145, and 155, are stored in one or more Wrapper Systems 115. In another embodiment, the wrappers, 125, 135, 145, and 155, are stored in the Data Processing System 110. The wrappers take in the tasks and configure the tasks in the formats suitable to the corresponding HRD collection systems. As described above, the wrappers could include a set of libraries for interacting with existing data collection mechanisms (e.g. Amazon Mechanical Turk, Y! Answers, Y! Suggestion Board, Floxter.com, etc). For example, for known Requesting System 50, the Data Processing System 110 might not need to collect known information, such as categories of products, which was supplied by the requester through Requesting System 50 previously. The libraries in the wrappers might have the needed categories of products to prepare tasks. In one embodiment, the wrappers, 125, 135, 145, and 155, are outside the HRD Collection Platform 110.

The Data Processing System 110 further includes a Result Poller component 113, in accordance with one embodiment of the present invention. The Task Dispatcher component 112 activates the Result Poller component 113. The Result Poller component 113 pings the wrappers, which in turn pings the respective HRD collection systems, at specified intervals to see if any new answer has been accumulated. The Result Poller component 113 retrieves new answers and sends them to a Result Analyzer component 114 of the Data Processing System 110. The Result Analyzer component 114 analyzes the answers collected so far for each task in order to determine whether the termination condition for collecting additional results has been met. For example, if the requester specifies to collect answers until 3 matched answers are collected, the Result Analyzer component 114 would analyze the result to determine if the 3 matched answers have been collected. If 3 matched answers have been collected, the Result Analyzer component 114 would invoke the Task Dispatcher component 112 to withdraw the task at the appropriate data collection system(s). If the termination condition has not been made, the Task Dispatcher component 112 would be invoked to request for more answers to be collected by the appropriate data collection system(s). Once the results (or answers) have been collected and have met the termination condition, the results are returned to the Requesting System 50, in accordance with one embodiment of the present invention. Alternatively, the results can be returned to the Requesting System 50 as they are being collected from the HRD collection systems, such as systems 1230, 130, 140 and 150, before the termination condition has been made.

In addition to the systems and components mentioned above, the Data Processing System 110, and the architecture of the Data Processing System 110, may also include additional innovative components. Experiments on Amazon Mechanical Turk (or Amazon MTurk) demonstrate that when the majority of 3 collected answers on each question is taken, the accuracy of the collected answer is higher than individual answer. For example, if two out of the collected answers list “Category-A” as the answer for a question shown in FIG. 2A and the other collected answer lists “Category-B” as the answer, it is more likely that “Category-A” is the correct answer. The accuracy of human reviewed data is judged by common sense of majority of people. For example, most of the people of agree that a camera should be categorized under “Electronics.” Taking the answer of the majority would normally work. Of course, there are always exceptions, such as the answers being given by 3 poor performing answerers. A voting algorithm helps analyzing the collected results.

In one embodiment, a voting algorithm requires the specification of the number of answers to collect and the voting threshold, which specifies the limit for a correct answer. Voting threshold can be determined by using gold-standard datasets. By issuing gold standard data set as HITs, the collected HRD answers based upon varying voting thresholds can be compared in accuracy against the known answers from the gold-standard dataset, and thereby determining an optimal voting threshold that maximizes accuracy. Gold-standard datasets consist of sets of tasks requiring human-review with expected answers. They are essentially sets of questions with known correct answers. The gold-standard datasets can be designed to be offered to different HRD collection systems and are independent of the HRD collection mechanisms. After submitting a subset of the questions from the gold-standard datasets to the HRD collection system(s), the answers returned by the system(s) can be compared with the known correct answers in order to compute an accuracy metric. For a given data application, by repeating the above tests using several distinct gold-standard datasets, each with a different combination of threshold and number of answers, the best combination (of threshold and number of answers) to use for a given accuracy and/or cost constraints can be found. For example, a data application, such as the ones shown in FIGS. 2A and 2B, using a collection system similar to Amazon MTurk might use a combination of 100 different answers with a threshold of 50%, which means at least 50 out of 100 answerers choosing a same answer to qualify the correct answer has been reached. The requester might pay the answerers 2 pennies for each answer; therefore, the requester only pays $2 for the answer. In contrast, the requester might use a different combination for a different HRD collection system, which may pay the answerers more, such as 5 pennies for each answer. If the requester needs to pay more for each answer, the requester would likely collect fewer answers and use a same or a different threshold, depending on the case. In one embodiment, the voting algorithm 171 is incorporated in the Result Analyzer component 114, as shown in FIG. 3B. As mentioned above, the Result Analyzer component 114 analyzes the answers collected for each task in order to determine whether the termination condition for collecting additional results has been met.

In one embodiment, the voting algorithm 171 assigns weight(s) to collected HRD according to source of the HRD collection system, and/or the identify of the answerer. Some HRD collection systems and answerers are assigned higher weights than others due to their known qualities. In another embodiment, the voting algorithm 171 specifies rules prioritizing HRD collected based on source of the HRD collection system, and/or the identify of the answerer. HRD collected from some HRD collection systems or from some answers have better qualities than others; therefore HRD collected from these HRD collection systems or from these answers are prioritized to be analyzed first.

In one embodiment, the Data Processing System 110 includes an algorithm for tracking answerers' accuracy. With gold standard datasets, the accuracy rate of individual answerers (or workers) who answered questions from the tasks can be computed. In one embodiment, the gold-standard tasks could be the first ones shown to the answerers (or workers). The system can be set up to accept answers only from those answerers who demonstrated accuracy above a certain threshold on the initial gold-standard dataset questions. In another embodiment, the gold-standard dataset questions can be dispersed amongst the other non-gold-standard questions posted over time, which would allow computing of an ongoing accuracy metric for participating answerers. Similarly, the system can be set up to accept only answers from those answerers whose accuracy is above a certain threshold. In yet another embodiment, gold-standard dataset questions can be the first ones shown to the answerers and also be dispersed amongst the other non-gold-standard questions to allow computing the accuracy rate of the answers in the beginning and in the middle of HRD collection. In another embodiment, the gold-standard dataset questions are dispersed amongst the other non-gold-standard questions posted over time, which would allow computing of an ongoing accuracy metric for each participating HRD collection system. In yet another embodiment, the Data Processing System 110 accept answers only from those HRD collection systems whose overall answerers' accuracies are above a certain threshold. In one embodiment, the algorithm for tracking answerers' accuracy 172 is incorporated in the Result Analyzer component 114, as shown in FIG. 3B.

In one embodiment, the Data Processing System 110 further includes an algorithm for abuse detection. A number of measures can be taken to detect answerers who are not being honest and/or paying attention while providing answers. For some HRD collection systems, such as Mechanical Turk and Y! Answers, timestamps are attached to answers. The timestamps on the answers by an individual on a set of questions can be reviewed to compute an average time spent per question. If the average time is negligible, then the answerer could be a suspect of using an automated system to generate the answers or perhaps just randomly providing answers without even looking at the questions. For multiple-choice questions, answerers who consistently choose a single answer or choose from the possible answers with about equal frequency (random choosing), could be suspects of abusing the HRD collection systems. Further, if an answerer consistently shows below-average accuracy on multiple gold-standard datasets, the answerer could also be a suspect for not answering the questions to the best of abilities or just being a poor-performing answerer that should be eliminated. In addition, if more detailed answerer information such as Internet IP address is available, inspection for multiple accounts originating from the same IP address can be performed to identify suspects of abusers for “stuffing the ballot (or answer) box”. In one embodiment, the algorithm for abuse detection is incorporated in the Result Analyzer component 114, as shown in FIG. 3B.

In another embodiment, the Data Processing System 110 includes an algorithm for self-validation of answers. For non-gold standard questions, the collected human answers can be fed back into the collection system(s) for verification. For example, suppose on Amazon MTurk, there is a type of tasks asking questions in the form of “What is the brand of product ‘xxx’?” We can create a new type of tasks, given the previously collected answers, asking questions such as “Is ‘y’ the brand of the product ‘xxx’?” An answer for a question in the form of “Is ‘y’ the brand of the product ‘xxx’?” only needs to decide if the answer is “yes” or “no”, which is simpler than choosing one answer out of a few possible answers. The Data Processing System 110 can have such an algorithm for self-validation of answers to verify the answer, which would improve the accuracy of the answer. In one embodiment, the algorithm for self-validation of answers is incorporated in the Result Analyzer component 114, as shown in FIG. 3B. Based on the results collected, the Result Analyzer component 114 can generate a self-validation task and send the new HITs to Task Dispatcher 112. Alternatively, the Result Analyzer 114 interacts with the Task Design component 111 to generate the self-validation task.

In yet another embodiment, the Data Processing System 110 includes an algorithm for parsing answers. As discussed above, on forums such as Y! Answers or Y! Suggestion Board, the answers tend to be conversational. Therefore, the answers require parsing to glean the answerer's meaning (or true answer). If multiple-choice question format (e.g. Which category is the product xxx in? Category-A? Category-B? Category-C?.), or equivalent alternatives such as polls, is available for the questions, it should certainly be used for its preciseness and simplicity for answerers. In some cases, free-text questions could be transformed to a multiple-choice question. For example, the question “What is the brand of product xxx?” could be transformed into the multiple-choice question “is the brand of product xxx A, B, or C.?”, where A, B, and C are automatically generated candidate brand values. For free-text questions, a library of common conversational patterns (e.g. “It's X”, “The brand is X”, “I would say X”) can be built to create regular expressions to extract answers based on the patterns. In some cases, we can validate answers. For example, suppose the question asks the answerer to enter the brand value from the product title ‘xxx’, any answer that is not a sub-string of ‘xxx’ is invalid and needs to be parsed out to obtain the true answer. In one embodiment, the algorithm for parsing answers to arrive at the true answers is incorporated in the Result Analyzer component 114, as shown in FIG. 3B.

The parsing functionality is typically placed in the wrapper(s); however, the functionality can also be in the Result Analyzer 114 (in Parsing Answers component 175), as discussed above. For example, the Mechanical Turk response comes in a proprietary format that needs to be parsed, as does the case for Yahoo! Answers. In the Yahoo! Answers case, once the answer string is parsed out (e.g. by the wrapper), such as “I think the brand is Sanford” being parsed out, there is still a need to further parse out the true answer (e.g. by the Parsing Answers component 175 in Result Analyzer 114), such as “Sanford.”

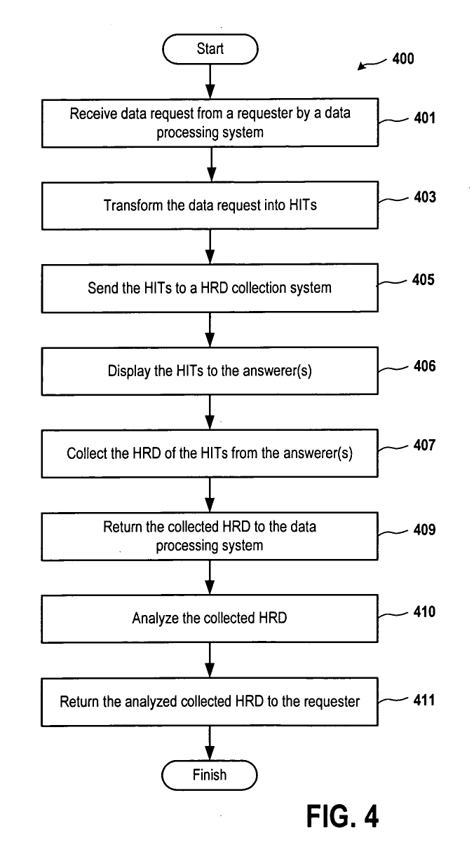

FIG. 4 shows a process flow 400 of collecting HRD from an automated HRD collection system. At step 401, data request is received by a data processing system. A requester interacts with the data processing system to enter the data request. In one embodiment, the data request includes all information needed to prepare human intelligence tasks (HITs) to collect the HRD. In another embodiment, some information needed to prepare the HITs is also stored in either the data processing system or the wrapper(s). At step 403, the data request is transformed into HITs. The transformation can be performed by the data processing system, or by a wrapper between the data processing system and the HRD collection system used to collect HRD, or a combination of both. In one embodiment, the task design component of the data processing system assist in the transformation.

At step 405, the HITs are sent to an HRD collection system. At step 406, the HRD collection system displays the HIT to the answerers, who view the HITs over the Internet. The task dispatcher component of the data processing system assists sending the HITs to the HRD collection system. The answerer(s) views (or receives) the HITs and provide the answers to the HITs, or provide HRD.

At step 407, The HRD collection system collects the answers (or inputs) from the answerers. The result poller component of the data processing system assist in collecting the HRD. At step 409, the HRD collection system returns the collected HRD (or answers) to the data processing system. In one embodiment, the collected HRD are transformed into formats useable by the data processing system. In another embodiment, the transformation is not necessary. The transformation can be performed by the data processing system, or by the wrapper between the data processing system and the HRD collection system used to collect HRD, or a combination of both.

At step 410, the HRD collection platform analyzes the collected HRD. The data processing system could use the various components in the data processing system to ensure the HRD returned are correct and meet the need of the requester. If the collected HRD do not meet the quality requirement, new HITs can be generated and sent to the HRD collection systems to collect additional HRD to ensure quality requirement is met. At step 411, the analyzed collected HRD are returned to the requester.

The embodiments discussed above provide methods and systems for automated collection of human-reviewed data. Requesters send data to be reviewed by humans (or data requests) to a data processing system, which is in communication with one or more systems for collecting human-reviewed data (HRD). The systems for collecting HRD can be systems for internal expert or editorial staff, systems for outsourced service-providers, systems for automated market place, such as Amazon MTurk, or systems for online question and answer or discussion forums.

The methods and systems discussed enables the data processing system to work with one or more of the systems for collecting HRD. In one embodiment, between the data processing system and the systems for collecting HRD are wrappers, which stores parameters specific to the data requests and libraries for transforming the data requests human intelligent tasks (HITs). The data processing system also includes a number of components that facilitate transforming data requests into HITs, sending the HITs to the HRD collection systems, receiving HRD, and analyzing HRD to improve the quality of collected HRD. The flexible systems and methods enable using the existing HRD collection systems with minimum amount of engineering. The systems and methods can be reused for different applications that consume HRD using different HRD collection systems. The features described enable harnessing the scale of Internet-based HRD collection system while ensuring the quality of the data collected.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data, which can be thereafter read by a computer system. The computer readable medium may also include an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The above-described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method of automated collection of human-reviewed data (HRD), comprising:
receiving a data request from a requester by a data processing system, wherein the data processing system defines a task design component, a task dispatcher component, a result poller component and a result analyzer component;
transforming the data request into one or more human intelligence tasks (HITs) with the assistance of the task design component of the data processing system, wherein each HIT is specific to a respective HRD collection system;
sending each HIT to the respective HRD collection system by using the task dispatcher component;
collecting the HRD from each HRD collection system with the assistance of the result poller component, wherein the HRD is provided by an answerer based on each HIT;
analyzing the collected HRD with the assistance of the analyzer component;
wherein the analysis improves the accuracy of the HRD; and
sending the analyzed collected HRD to the requester.

2. The method of claim 1, wherein the analysis includes using a voting algorithm to select the collected HRD to be sent to the requester, the voting algorithm specifying a number of the collected HRD and a voting threshold.

3. The method of claim 2, wherein the collected HRD are weighted according to source of the HRD collection system, and/or the identify of the answerer.

4. The method of claim 2, wherein the voting algorithm specifies rules prioritizing HRD based on source of the HRD collection system, and/or the identify of the answerer.

5. The method of claim 1, wherein the analysis includes using an algorithm for tracking answerers' accuracy to accept HRD only from answerers whose accuracy rates pass a threshold, the algorithm for tracking answerers' accuracy using gold-standard tasks to track answerers' accuracy.

6. The method of claim 1, wherein the analysis includes using an algorithm for abuse detection to detect answerers who abuse the HRD collection system, the algorithm for abuse detection using timestamps and accuracy threshold to detect abuse.

7. The method of claim 1, wherein the analysis includes using an algorithm for self-validation of answers to improve the accuracy of collected HRD, the algorithm for self-validation of answers enabling creation of new HITs based on collected HRD.

8. The method of claim 2, wherein the analysis includes using an algorithm for self-validation of answers to improve the accuracy of collected HRD, the algorithm for self-validation of answers enabling creation of new HITs to send to HRD collection system when the voting algorithm fails to select the collected HRD to be sent to the requester.

9. The method of claim 1, wherein the analysis includes using an algorithm for parsing answers to extract true answers of the collected HRD from the HRD collection system.

10. The method of claim 1, wherein there is a wrapper between the data processing system and the HRD collection system, and wherein the task design component of the data processing system and the wrapper work together to transform the data request into the one or more human intelligence tasks (HITs).

11. The method of claim 7, wherein the wrapper has a library containing information specific to the HRD collection system, and wherein information in the library is used in transforming the data request into one or more HITs.

12. The method of claim 7, wherein the wrapper has one or more components, which includes a collection system parameter store, a data parameter store, a library, a data store, and a processing component.

13. The method of claim 1, wherein the respective HRD collection system is an Internet-based automated market place, where the answerer is an Internet user.

14. The method of claim 1, wherein the respective HRD collection system is an on-line discussion forum, an online application, or an online interface, whose users provide answer.

15. A system for automated collection of human-reviewed data (HRD), comprising:
a data processing system for receiving data request from a requester;
an HRD collection system for collecting HRD corresponding to a human intelligence task (HIT) generated from the data request, wherein the HRD collected are entered by an answerer interacting with the HRD collection system; and
a system with a wrapper between the data processing system and the HRD collection system, wherein the wrapper and the data processing system transform the received data request into the HIT to be sent to the HRD collection system for the answerer to view to prepare the HRD corresponding to the data request, and wherein the wrapper and the data processing system analyze the collected HRD to improve the accuracy of the HRD collected.

16. The system of claim 15, further comprises a requesting system, which is in communication with the data processing system and allows the requester to enter data request.

17. The system of claim 15, further comprises a system for the answerer, which is in communication with the HRD collection system and allows the answerer to enter the HRD corresponding to the data request.

18. The system of claim 15, wherein the data processing system includes one or more algorithms for voting, tracking answerers' accuracy, abuse detection, self-validation of answers, and parsing answers.

19. The system of claim 15, wherein the wrapper has one or more components, which includes a collection system parameter store, a data parameter store, a library, a data store, and a processing component.

20. The system of claim 19, wherein the wrapper has a library component, and wherein the information in the library component is used to transform the data request into HIT to be sent to the HRD collection system.

21. The system of claim 15, wherein the data processing system has a task design component, a task dispatcher component, a result poller component, and a result analyzer component.

22. Computer readable media including program instructions for automated collection of human-reviewed data (HRD), comprising:
program instructions for receiving a data request from a requester by a data processing system, wherein the data processing system defines a task design component, a task dispatcher component, a result poller component and a result analyzer component;
program instructions for transforming the data request into one or more human intelligence tasks (HITs) with the assistance of the task design component of the data processing system, wherein each HIT is specific to a respective HRD collection system;
program instructions for sending each HIT to the respective HRD collection system by using the task dispatcher component;
program instructions for collecting the HRD from each HRD collection system with the assistance of the result poller component, wherein the HRD is provided by an answerer based on each HIT;
program instructions for analyzing the collected HRD with the assistance of the analyzer component; wherein the analysis improves the accuracy of the HRD collected; and
program instructions for sending the analyzed collected HRD to the requester.

23. The computer readable media of claim 22, wherein the analysis using one or more algorithms for voting, tracking answerers' accuracy, abuse detection, self-validation of answers, and parsing answers.

24. The computer readable media of claim 22, wherein there is a wrapper between the data processing system and the HRD collection system, and wherein the data processing system and the wrapper transform the data request into the one or more human intelligence tasks (HITs), which is specific to the HRD collection system.

25. The computer readable media of claim 24, wherein the wrapper has one or more components, which includes a collection system parameter store, a data parameter store, a library, a data store, and a processing component.
